(19) United States
(12) Patent Application Publication
(10) Pub. No.: US 2018/0054746 A1
(43) Pub. Date: Feb. 22, 2018

(54) SYSTEMS AND METHODS FOR OFFSET SCHEDULING IN WIRELESS NETWORKS

(71) Applicant: Alcatel-Lucent USA, Inc., Murray Hill, NJ (US)

(72) Inventors: Krishna Balachandran, Morganville, NJ (US); Joseph H. Kang, Belle Mead, NJ (US); Kemal M. Karakayali, Hoboken, NJ (US); Kiran M. Rege, Marlboro, NJ (US)

(73) Assignee: Alcatel-Lucent USA, Inc., Murray Hill, NJ (US)

(21) Appl. No.: 15/242,596

(22) Filed: Aug. 21, 2016

(51) Int. Cl. H04W 24/02; H04W 72/04; H04W 76/04

(52) U.S. Cl. CPC H04W 24/02; H04W 72/0406; H04W 88/02; H04W 76/046; H04W 72/044

(57) ABSTRACT

The efficiency of uplink data channels provided by a wireless cell is increased by using offset scheduling grants to control the transmission of data payloads from user equipment to the cell.

### INTRODUCTION

As cellular networks continue to evolve beyond Long-Term Evolution (LTE) networks, it is widely recognized that network densification (i.e., more cells per network, heterogonous wireless networks (“HetNets”) with overlaid macro-cells and small-cells) is needed to address the need for higher network throughput and to improve end-user Quality of Experience (QoE). However, excessive interference and bottlenecks in resource allocation/control processes create inefficiencies that limit the QoE for a significant number of users of user equipment (UE).

In a typical cellular communication network, physical channels can be broadly grouped into two categories: control channels and data channels. Control channels provide signals that include basic information necessary to establish communications between transmitters and receivers (e.g. time/frequency resources in which data transmission will occur, modulation/coding format selections, hybrid automatic repeat request feedback information etc.) while data channels mainly carry data payloads (sometimes referred to simply a “data”).

A typical cellular network site (i.e., a “cell”) consists of a base station for transmitting control signals (e.g. scheduling grants) to a UE over a downlink control channel. A cell that transmits control signals to a particular UE is referred to as the “serving cell” for that UE. The control signals received by the UE enable the UE to, thereafter, transmit data payloads over an uplink data channel that is established between the UE and the same serving cell.

One such bottleneck that occurs in existing cellular networks is due to the strict timing requirements that govern the transmission of control signals via a downlink control channel and the transmission of data payloads via an uplink data channel. Typically, there is a fixed time period or “lag” between the transmission of such control signals carrying a scheduling grant (indicating the resources and modulation/coding formats to be used) and the corresponding transmission of data payloads. This is referred to as “timing coupling.” Timing coupling creates inefficiencies that limit the QoE for a significant number of users of UEs, especially those that must rely on transmitting data payloads via the uplink of a cell in a HetNet.

In more detail, to adhere to existing timing coupling requirements data payloads must be transmitted via an uplink data channel from a UE to a cell (e.g., macro-cell, small-cell) in accordance with a fixed schedule/timeline after receipt of corresponding control signals via a downlink control channel from the cell. For instance, in a 3GPP-LTE network, the control signals, transmitted from a cell to a UE starting at time t, via a physical downlink control channel (PDCCH) initiates the transmission of data payloads from the UE to the cell via a physical uplink data shared channel (PUSCH) at a fixed time t+4 milliseconds (i.e., within four milliseconds of receipt of the PDCCH control signal).

Referring now to FIG. 1A there is depicted a typical, exemplary HetNet network 1. The network 1 includes a low-power small-cell 4 deployed within the coverage area 5 of a high-power macro-cell 2. Because macro-cell 2 typically transmits control signals via the downlink control channel 8 at a power level that is substantially higher than the control signals that are transmitted from the small-cell 4 via its downlink control channel (not shown in FIG. 1A), typically −16 dB higher, only those UEs (e.g., mobile devices) close to the small-cell 4 can reliably receive control signals from the small-cell 4. In effect, this limits the coverage area 6 of the small-cell 4.

To enlarge the effective coverage area of small-cells, such as small cell 4, one suggested solution requires the use of so-called “blanked” or muted sub-frames.

In more detail, referring now to FIG. 1B, in 3GPP-LTE Release 10, enhanced Inter-cell Interference Coordination (eICIC) techniques are introduced to expand the coverage area of a small-cell. One such technique requires a macro-cell, such as cell 2, to refrain from transmitting control or data signals to a UE (e.g., UE 3) during certain periods of time referred to as sub-frames, effectively muting or blanking those sub-frames. Because transmissions of most control and data signals from a macro-cell are blocked during these blanked sub-frames, a UE (again, e.g., UE 3) associated with a small-cell (e.g., cell 4) can reliably receive control signals from that small cell instead, without interference from the macro-cell (e.g., cell 2). In the exemplary, existing network 1 in FIGS. 1A and 1B, 35% of the frames from the macro-cell 2 are assumed to be blanked, with the cell 2 using a 9 dB association bias (i.e., UE 3 will connect to the macro-cell 2 if the strength of control signals transmitted from the cell 2 to UE 3, as measured by UE 3, via downlink control channel 8 is at least 9 dB higher than the strength of control signals transmitted from the small-cell 4 to UE 3 (again, as measured by UE 3)). By allowing a UE to receive control signals from a small cell with little or no interference from a macro cell, the effective coverage area of the small cell expands from its original coverage area (e.g., area 6 in FIG. 1B) to an expanded coverage area (e.g., area 7 in FIG. 1B).

As we noted previously, a control signal transmitted from cell 2 via downlink control channel 8 to UE 3 requires UE 3 to send data payloads via uplink data channel 9 within a fixed time period of four milliseconds. However, using the suggested eICIC technique as a solution to expand the coverage area of the small cell 4-, certain sub-frames are muted at the macro-cell 2. Accordingly, no control signals are transmitted from the cell 2 during these muted sub-frames. Nonetheless, the UE 3 has been pre-programmed to send data payloads via uplink data channel 9 to cell 2 after four milliseconds. However, absent a control signal (during these blanked sub-frames), the UE 3 will not be able to transmit any actual data (i.e., no payload) during the sub-frames that occur 4 milliseconds after the muted sub-frames. This is highly inefficient.

As discussed above, if 35% of the sub-frames are blanked to support a 9 dB admission bias, then 35% of the time allotted for the transmission of data payloads between a UE and its serving cell will be lost because the UE will not be able to transmit any data payloads during sub-frames occurring within the 4 millisecond time period after a blanked sub-frame.

Thus, the suggested eICIC techniques have their disadvantages and drawbacks.

It should be noted that the suggested eICIC techniques use sub-frames that are almost muted or blanked (not completely muted or blanked) in the sense that during such sub-frames data payloads and most control messages are not transmitted. However, during these blanked frames (time periods), basic control signals, such as cell-specific reference signals (CRS) are still transmitted. Accordingly, it has also been suggested that employing higher biases (e.g., 14 dB) with an advanced UE that employs, for instance, interference-cancelation on control channels (e.g. CRS cancelation) may allow UEs to become associated with a small-cell, instead of a macro-cell, thus increasing its effective coverage area. Unfortunately, this solution also has it drawbacks. For example, a higher bias would probably require that a higher number of sub-frames be muted at a macro-cell in order to ensure reliable reception of control signals from a small-cell by UEs within the expanded coverage area of the small cell. In other words, the use of a higher bias leads to a larger, small-cell coverage area but comes at the cost of further underutilization of uplink data channels available from a macro-cell (i.e., severe timing coupling problem).

Accordingly, it is desirable to provide systems and methods that address the timing coupling problems outlined above while providing a user with a high QoE, and without sacrificing the efficiency of a macro-cell.

### SUMMARY

We have recognized that problems with existing techniques for improving the efficiency of cells in a wireless network can be overcome by systems and methods that provide offset scheduling grants.

In accordance with embodiments of the invention, the timing of the transmission of data payloads via an uplink data channel can be indicated by transmitting control signals that are offset in time from their ordinary time frames via downlink control channels. The offsets effectively break the tight timing coupling between the delivery of control signals via a downlink control channel and the responsive delivery of data payloads via uplink data channels. This, in turn, improves the utilization of uplink data channels for cells in a HetNet that employ sub-frame blanking because it allows UEs associated with a macro-cell to utilize the time periods associated with blanked sub-frames.

In one embodiment, rather than using a fixed offset value of 4 milliseconds, data payloads may now be sent from a UE to a macro-cell (i.e., serving cell) using a variable uplink response time value (“variable value”), denoted “A” (or t+Δ)

In more detail, one embodiment comprises a radio-frequency (RF) wireless system comprising: a hardware controller operable to generate an offset scheduling grant, within a downlink control signal sub-frame of a frame, that comprises a variable uplink response time value for controlling the time user equipment sends data payloads to a wireless cell via an uplink data channel. The variable value may be less than, or more than, a fixed value (less than or more than 4 milliseconds).

The exemplary system may further comprise a transceiver that is operable to transmit the grant to the user equipment during the downlink control signal sub-frame via a downlink control channel.

In embodiments of the invention, the controller may be part of a serving cell, non-serving cell or a network management system (NMS).

In addition to a controller and transceiver located at a cell or NMS, an inventive system may further comprise user equipment. Such user equipment may be operable to receive a scheduling grant during the downlink control signal sub-frame via a downlink control channel from a cell and to transmit the data payloads via the uplink data channel at a time indicated by the grant to the cell.

In addition to generating variable offset scheduling grants, controllers provided by the present invention may also generate one or more blanking sub-frames during a frame. Thereafter, a transceiver may be operable to transmit the grants to the user equipment during one or more downlink control signal sub-frames of the frame that are not blanking sub-frames via a broadcast channel.

In yet a further embodiment, before transmitting a grant to user equipment, the controller may be further operable to identify the highest quality available uplink data channel for transmitting the data payloads from the user equipment to a cell (either one where the controller is located, or another cell) based on channel quality measurements (e.g., signal strength measurements, and time-averaged instantaneous interference statistics).

In addition to the systems described above, the present invention also provides methods for improving the efficiency of wireless cells. On such method comprises generating, by a hardware controller, an offset scheduling grant, within a downlink control signal sub-frame of a frame, that comprises a variable uplink response time value for controlling the time user equipment sends data payloads to a wireless cell via an uplink data channel. The controller may be part of a serving cell, non-serving cell or an NMS

The variable value may be less than, or more than, a fixed value (e.g., 4 milliseconds).

The method may further comprise (1) transmitting, from a transceiver, the grant to the user equipment during the downlink control signal sub-frame via a downlink control channel; (2) receiving, at the user equipment, the grant during the downlink control signal sub-frame via a downlink control channel and transmitting, from the user equipment, the data payloads via the uplink data channel at a time indicated by the grant; (3) generating, by the controller one or more blanking sub-frames during the frame, and transmitting the grant from a transceiver to the user equipment during one or more downlink control signal sub-frames of the frame that are not blanking sub-frames via a broadcast channel; and (4) receiving the grant at the user equipment during the downlink control signal sub-frame via a downlink control channel and transmitting the data payloads from the user equipment via the uplink data channel at a time indicated by the grant.

As before, prior to generating and transmitting a grant, the method may additional comprise identifying, by the controller, the highest quality available uplink data channel for transmitting the data payloads from the user equipment to a cell based on channel quality measurements (e.g., signal strength measurements, and time-averaged instantaneous interference statistics).

Additional systems and methods will be apparent from the following detailed description and appended drawings.

### BRIEF DESCRIPTION OF THE DRAWINGS

FIGS. 1A and 1B depict an existing wireless network.

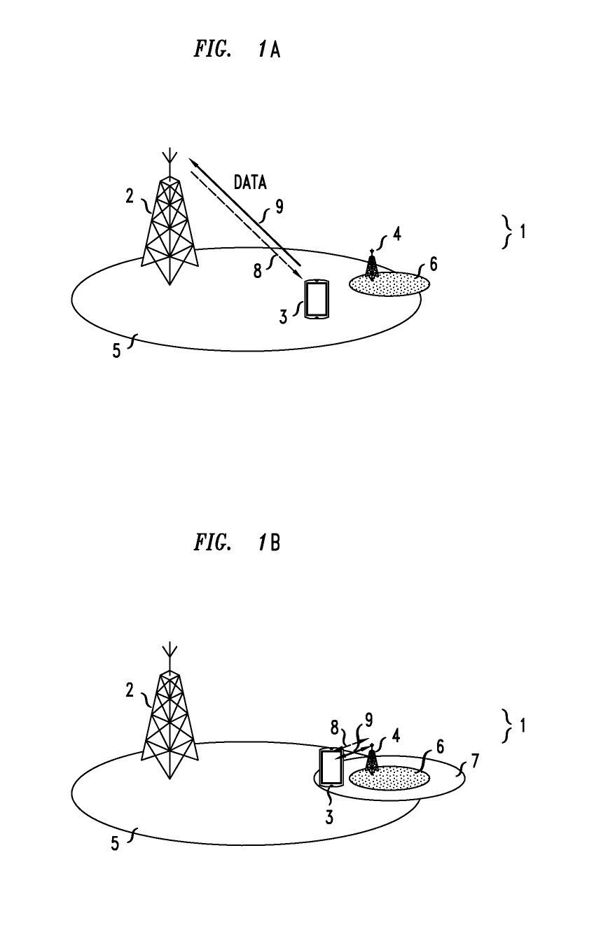

FIG. 2A depicts a wireless network that utilizes inventive offsets according to embodiments of the invention.

FIG. 2B depicts an exemplary base station of a macro-cell according to an embodiment of the invention.

FIG. 2C depicts exemplary user equipment according to an embodiment of the invention.

FIG. 3 depicts a simplified flowchart of exemplary methods according to embodiments of the invention.

### DETAILED DESCRIPTION

Exemplary embodiments of systems and methods for providing offset scheduling in RF wireless networks are described herein and are shown by way of example in the drawings. Throughout the following description and drawings, like reference numbers/characters refer to like elements.

It should be understood that, although specific exemplary embodiments are discussed herein, there is no intent to limit the scope of the present invention to such embodiments. To the contrary, it should be understood that the exemplary embodiments discussed herein are for illustrative purposes, and that modified and alternative embodiments may be implemented without departing from the scope of the present invention.

It should also be noted that one or more exemplary embodiments may be described as a process or method. Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method.

As used herein, the term “and/or” includes any and all combinations of one or more of the associated listed items. As used herein, the singular forms “a,” “an” and “the” are intended to include the plural form, unless the context and/or common sense indicates otherwise.

It should be understood that when a component or element of an inventive system is referred to, or shown in a figure, as being “connected” to (or other tenses of connected) another component or element such components or elements can be directly connected, or may use intervening components or elements to aid a connection. In the latter case, if the intervening components and elements are well known to those in the art they may not be described herein.

When used herein the phrase “hardware controller” means an electronic device such as a microchip, expansion card, or a stand-alone device that interfaces with memory and uses stored electronic instructions to control and manage the operation of a larger device or system, such as a base station.

When the words “first” or “second” or other similar words denoting a number are used it should be understood that the use of these words does not denote a level of importance or priority. Rather, such words are used to merely distinguish one element or component from another. Relatedly, it should be understood that one or more of these elements or components may be combined to form fewer elements/components, or, may be further divided to form additional elements/components.

As used herein the term “macro-cell” means a system that transmits and receives radio frequency (RF) signals and data payloads at (relatively) high power levels. It should be understood that a macro-cell may comprise a fixed (by location) transceiver that is a part of a base station. Typically, the coverage area of a macro-cell is between 500 meters to several kilometers.

As used herein the phrase “small-cell” means a system that transmits and receives RF signals and data payloads using low-power levels. Typically, a small cell has a coverage area of 10 meters to a few hundred meters.

As used herein the term “cell” means a macro-cell or a small cell.

Connected together, macro-cells and small-cells make up a wireless network.

When used herein the phrase “user equipment” or UE includes all types of mobile devices, such as phones, laptop computers, desktop computers, tablets, phablets or any other device that can be used by a user that is moving from one location to another and that is equipped with the necessary electronics to send and receive signals and data payloads over a wireless RF network.

As used herein, the term “embodiment” refers to an example of the present invention.

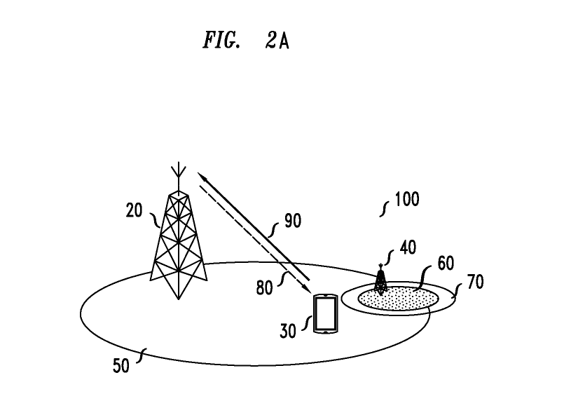

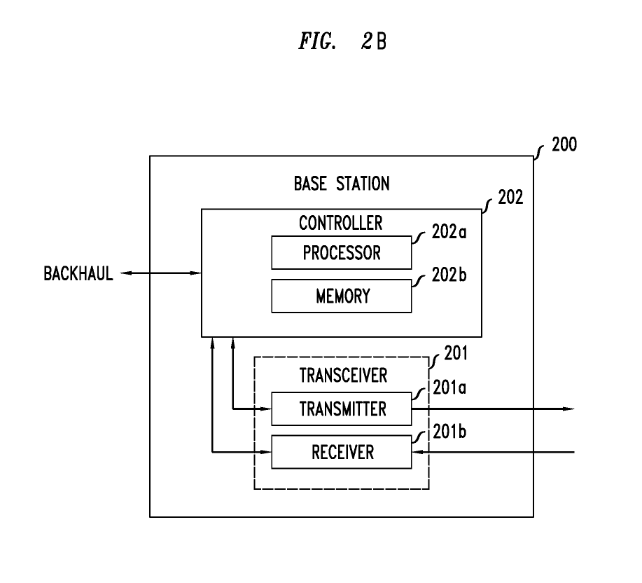

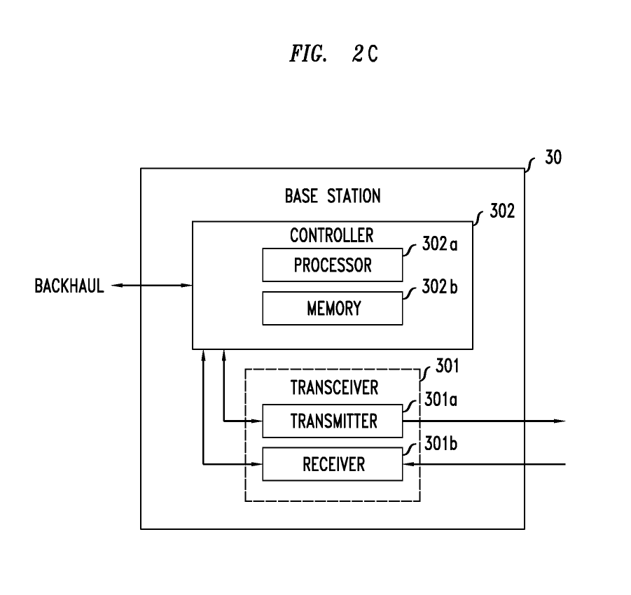

Referring now to FIG. 2A there is depicted a system 100 according to one embodiment. System 100 comprises an RF wireless serving cell 20, UE 30, and RF wireless non-serving cell 40, the latter two components within the coverage area 50 of the serving cell 20. In an embodiment, the serving cell 20 may be a macro-cell while the non-serving cell 40 may be a small-cell. The components of system 100 may be part of a 5G wireless network, for example.

In one embodiment, the inventive serving cell 20 may be operable to generate a plurality of downlink control signals, and send these signals during set time frames in accordance with a generated time schedule. For example, in a Long-Term Evolution (LTE) based system a frame has duration of 10 milliseconds, and one frame may comprise 10 sub-frames. Further, typically each sub-frame has a duration of 1 millisecond. In more detail, within a particular frame the serving cell 20 may be operable to transmit a full set of control signals during certain sub-frames of the frame, or may only transmit basic control signals during other sub-frames (the latter being blanked or muted sub-frames) to the UE 30. In one embodiment, the cell 20 may be operable to send an indication (e.g., values) of those sub-frames that will be blanked during a particular frame to the UE 30 via a broadcast channel (not shown in FIG. 2A), not via its downlink control channel 80.

More particularly, the serving cell 20 may be operable to generate a downlink control signal frame that includes a plurality of sub-frames where one or more of the sub-frames include a full set of control signals, including an offset scheduling grant (i.e., those sub-frames where downlink transmissions are not blanked), where the grant comprises a variable uplink response time value, A, (variable value) for controlling the time that the UE 30 transmits data payloads to the cell 20. The so generated grant may be transmitted to the UE 30 from the cell 20 via downlink control channel 80.

Upon receiving the offset scheduling grant, the UE 30 is operable to transmit data payloads, via an uplink data channel 90 established between the UE 30 and cell 20, at a time indicated by the offset time indicator, i.e., the variable value, instead of after a fixed offset (i.e., four milliseconds after a blanked sub-frame is received). By transmitting data payloads in accordance with the variable value, the time period within which the UE 30 must transmit its data payload(s) to cell 20 may be effectively varied. For example, the UE 30 may transmit data payloads before, or after, the 4 millisecond time period associated with the typical fixed offset. The net result is that the UE 30 may now transmit data using uplink data channels provided by the cell 20 during any sub-frame, notwithstanding the fact that the cell 20 is not transmitting control signals during blanked sub-frames. The inventors believe this will lead to more efficient use of the uplink channels provided by the cell 20.

In embodiments of the invention, the variable value may be more or less than four milliseconds.

In an alternative embodiment before the cell 20 transmits the grant to the UE 30, the cell 20 may be operable to identify the highest quality available uplink data channel for transmitting data payloads from the UE 30 to the cell 20. In an embodiment, the cell 20 may be operable to identify such a channel based on channel quality measurements (e.g. CQI reports). Further, because data payloads may be transmitted before or after the traditional four millisecond time period, in accordance with another embodiment the cell 20 may be further operable to verify that the uplink data channel previously selected as the highest quality channel based on CQI measurements is, in fact, still the highest quality channel at the time the data payloads will be transmitted (i.e., at time t+Δ)

In more detail, the cell 20 may be operable to select the uplink data channel that is expected to be the highest quality uplink data channel during the sub-frame in which data payloads will actually be transmitted based on the variable value and based on signal strength measurements, and time-averaged instantaneous interference statistics used to compute CQI information. This capability addresses the need to accommodate potential backhaul delays and changes in the CQI.

By using the inventive variable offset scheduling grants, sub-frames in an uplink data channel that would normally be empty due to the use of blanked or muted downlink sub-frames can now be filled with data payloads. This may be particularly important in high-bias scenarios where a large number of sub-frames may need to be muted at the macro-cell (e.g. half of the frames may need to be muted with 14 dB bias).

Referring now to FIG. 2B, macro-cell 20 may comprise a base station 200. In one embodiment, base station 200 may include a transceiver 201 (e.g., combination of a transmitter 201a and receiver 201b) for exchanging control signals with the UE 30 as well as a hardware controller 202 that may comprise one or more processors 202a, and associated memory 202b. The processor 202a may be operable to generate the control signals that are sent to the UE 30 based on executing instructions stored in memory 202b and process responsive signals received from the UE 30. When the macro-cell 20 is referred to herein as being “operable to” perform a specified feature, function or process, it should be understood that this means the components of its base station 200 are completing the feature, function or process.

In more detail, the hardware controller 202 may be operable to generate the offset scheduling grants, and variable values based on estimates of channel quality measurements (at the time the data payloads from the UE 30 may be transmitted), signal strength measurements, and time-averaged instantaneous interference statistics that it measures (using instructions stored in its memory 202b). The controller 202 may also generate the sub-frames to be blanked for a given frame. Alternatively, the cell 20 may receive all or some of the above (e.g., offset scheduling grants, variable values, channel quality measurements, signal strength measurements, time-averaged instantaneous interference statistics, and information indicating the sub-frames to be blanked) based on information received from a network management system (NMS) that need not be co-located (i.e., is separate from) with the cell 20.

In the latter case, the NMS may be operable to generate the offset scheduling grants, and variable values, information indicating the sub-frames to be blanked, as well as generate the channel quality measurements, signal strength measurements, and time-averaged instantaneous interference statistics using its components, such as its own hardware controller (e.g., controller 202), for example, and then send them to the cell 20 using its own transceiver.

Referring to FIG. 2C, UE 30 may include a transceiver 301 (transmitter 301a and receiver 301b) for receiving and exchanging control signals, including the offset scheduling grants, and variable values, with the cell 20, and transmitting data payloads to the cell 20 (or cell 40). The UE 30 may further include a controller 302 that may comprise one or more processors 302a and associated memory 302b. The processor 302a may be operable to generate the necessary internal signals for receiving the control signals and for transmitting the data payloads via uplink data channel 90 in accordance with the offset scheduling grants, and variable values included in the signals the UE 30 receives form the cell 20 via downlink control channel 80.

The processor 302a may rely upon instructions stored in memory 302b to complete these functions, for example. When the UE 30 is referred to herein as being “operable to” perform a specified feature, function or process, it should be understood that this means its transceiver 301, processor 302a and/or memory 302b, or some combination of the above components complete the feature, function and process.

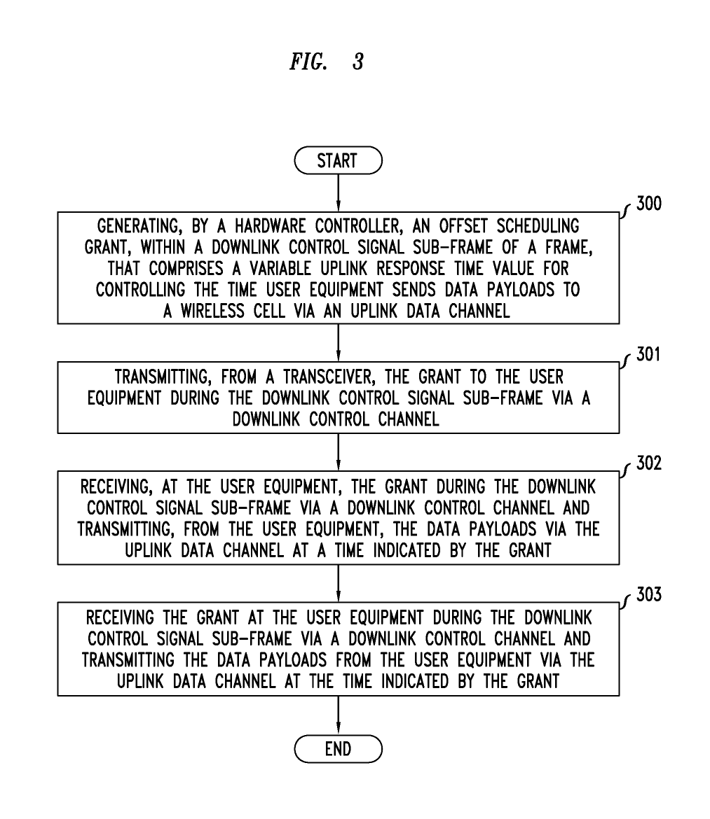

FIG. 3 depicts an exemplary method for improving the efficiency of wireless cells that makes use of the systems described above and elsewhere herein.

The foregoing description only describes a few of the many possible embodiments of the invention. Numerous changes and modifications to the embodiments disclosed herein may be made without departing from the spirit and scope of the invention. For example, while only two cells are utilized in the examples described herein, it should be understood that more cells may be utilized in the inventive systems and methods. The metes and bounds of the scope of the present invention are best defined by the claims that follow.

What is claimed is:

1. A radio-frequency (RF) wireless system comprising:
a hardware controller operable to generate an offset scheduling grant, within a downlink control signal sub-frame of a frame, that comprises a variable uplink response time value for controlling the time user equipment sends data payloads to a wireless cell via an uplink data channel.

2. The system as in claim 1 wherein the variable value is less than, or more than, a fixed value.

3. The system as in claim 1 wherein the fixed value is 4 milliseconds.

4. The system as in claim 1 further comprising a transceiver operable to transmit the grant to the user equipment during the downlink control signal sub-frame via a downlink control channel.

5. The system as in claim 1 wherein the controller is part of a serving cell, non-serving cell or a network management system.

6. The system as in claim 1 further comprising user equipment operable to receive the grant during the downlink control signal sub-frame via a downlink control channel and to transmit the data payloads via the uplink data channel at a time indicated by the grant. The system as in claim 1 wherein the controller is further operable to generate one or more blanking sub-frames during the frame, and the system further comprises a transceiver operable to transmit the grant to the user equipment during one or more downlink control signal sub-frames of the frame that are not blanking sub-frames via a broadcast channel.

8. The system as in claim 7 wherein the system comprises user equipment operable to receive the grant during the downlink control signal sub-frame via a downlink control channel and to transmit the data payloads via the uplink data channel at a time indicated by the grant.

9. The system as in claim 1 wherein the controller is further operable to identify the highest quality available uplink data channel for transmitting the data payloads from the user equipment to a cell based on channel quality measurements.

10. The system as in claim 9 wherein the channel quality measurements comprise signal strength measurements, and time-averaged instantaneous interference statistics.

11. A method for improving the efficiency of wireless cells comprising:
generating, by a hardware controller, an offset scheduling grant, within a downlink control signal sub-frame of a frame, that comprises a variable uplink response time value for controlling the time user equipment sends data payloads to a wireless cell via an uplink data channel.

12. The method as in claim 11 wherein the variable value is less than, or more than, a fixed value.

13. The method as in claim 11 wherein the fixed value is 4 milliseconds.

14. The method as in claim 11 further comprising transmitting, from a transceiver, the grant to the user equipment during the downlink control signal sub-frame via a downlink control channel.

15. The method as in claim 11 wherein the controller is part of a serving cell, non-serving cell or a network management system.

16. The method as in claim 11 further comprising receiving, at the user equipment, the grant during the downlink control signal sub-frame via a downlink control channel and transmitting, from the user equipment, the data payloads via the uplink data channel at a time indicated by the grant.

17. The method as in claim 11 further comprising generating, by the controller one or more blanking sub-frames during the frame, and transmitting the grant from a transceiver to the user equipment during one or more downlink control signal sub-frames of the frame that are not blanking sub-frames via a broadcast channel.

18. The method as in claim 17 further comprising receiving the grant at the user equipment during the downlink control signal sub-frame via a downlink control channel and transmitting the data payloads from the user equipment via the uplink data channel at a time indicated by the grant.

19. The method as in claim 11 further comprising identifying, by the controller, the highest quality available uplink data channel for transmitting the data payloads from the user equipment to a cell based on channel quality measurements.

20. The method as in claim 19 wherein the channel quality measurements comprise signal strength measurements, and time-averaged instantaneous interference statistics.
